(19) United States
(12) Patent Application Publication
(10) Pub. No.: US 2006/0041552 A1
(43) Pub. Date: Feb. 23, 2006

(54) Electronic information searching apparatus, method of searching electronic information and program for the same

(75) Inventor: Yuzuru Koga, Tokorozawa (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/043,068

(22) Filed: Jan. 27, 2005

(30) Foreign Application Priority Data
Aug. 18, 2004 (JP) 2004-237930

(51) Int. Cl. G06F 17/30

(52) U.S. Cl. 707/6

(57) ABSTRACT

An electronic information searching apparatus improves search velocity by sharing the process with a plurality of personal computers at the time of searching the received mails. The electronic information searching apparatus of the present invention is the apparatus connected to the network to make communication wit the other information processing, comprising a storage unit for storing the electronic information, an electronic information matching processing unit for conducting the matching process between the electronic information and the electronic information stored in the other information processing apparatus, an electronic information sharing determining unit for determining the sharing of the electronic information to be searched of the electronic information having completed the matching process, and an electronic information searching unit for searching the determined shared electronic information.

### CROSS REFERENCE TO RELATED APPLICATION

This application is related to and claims priority to Japanese Application No. 2004-237930, filed Aug. 18, 2004 in the Japanese Patent Office, the contents of which are incorporated by reference herein.

### BACKGROUND OF THE INVENTION

1. Field of the Invention

The present invention relates to an information processing apparatus having a function to search electronic mails received through a network.

2. Description of the Related Art

In recent years, the number of users who are connecting a plurality of personal computers through a network is increasing because personal computers and network infrastructure can be obtained at a lower price than in the past.

Moreover, electronic mails are often used for businesses and therefore a large number of users are transmitting and receiving a large number of mails every day.

Since the received mails are very important for businesses, a mail information matching process is also executed periodically or non-periodically with a plurality of personal computers used in order to prepare for the backup of data.

Here, the main information matching process means that the mail information stored in a plurality of personal computers is matched. For example, when two personal computers are used, if one personal computer stores the mails A, B, and E and the other personal computer stores the mails C, D, and F, the mails A, B, C, D, E, and F are stored in both personal computers.

The following patent document is considered as prior art regarding a system for executing the mail information matching process.

Japanese Patent Application Laid-Open No. 03-78568 discloses an electronic mail distributing system which can distribute the mails received by one mail address and the mails received by another mail address to both ways.

However, this system neither shares the mail searching process with a plurality of computers nor improves the searching velocity.

Therefore, at the time of searching the received mails, the searching process is executed only with a personal computer which has received the mails, even when a plurality of personal computers are available. Therefore, although computer performance has been improved, considerable time is required at present to search the contents of all mails.

### SUMMARY OF THE INVENTION

Under the condition that a plurality of personal computers always or intermittently connect the mails received or transmitted from one or a plurality of mail counts through the network and execute a mail information matching process on the received mails in a plurality of information processing apparatuses of the same user, it is an object of the present invention that a plurality of personal computers share the search processes to search the received mails in order to improve the searching velocity.

The electronic information searching apparatus of the present invention is an apparatus connected to a network for communicating with other information processing apparatuses, and which comprises a storage unit for storing the electronic information, an electronic information matching processing unit for conducting the matching process between the electronic information and the electronic information stored in the other information processing apparatus, an electronic information sharing determining unit for determining the sharing of electronic information to be searched of the electronic information having completed the electronic information matching process, and an electronic information searching unit for searching the determined shared electronic information.

Moreover, the electronic information searching apparatus of the present invention is characterized in that the electronic information searching unit completes the search of the determined shared information and assists the search of the other information processing apparatus when the search of the other information processing apparatus is not yet completed.

Moreover, the electronic information searching apparatus is characterized in that the electronic information is non-voice information transmitted and received by the information processing apparatus.

Moreover, the electronic information searching program of the present invention is an electronic information searching program for searching the electronic information stored in the information processing apparatus in combination with the other information processing apparatus connected to the network, comprising controlling a computer to execute the electronic information matching processing step for conducting the matching process between the electronic information of the other information processing apparatus and the stored electronic information, the electronic information sharing determining step for determining the sharing of the electronic information to be searched of the electronic information having completed the matching process, and the electronic information searching step for searching the electronic information for searching the determined sharing of search of the electronic information.

Moreover, the electronic information searching method of the present invention is an electronic information searching method for searching the electronic information stored in the information processing apparatus in combination with the other information processing apparatus connected to the network, comprising the electronic information matching processing procedure for conducting the matching process between the electronic information of the other information processing apparatus and the stored electronic information, the electronic information sharing determining procedure for determining the sharing of the electronic information to be searched of the electronic information having completed the matching process, and the electronic information searching procedure for searching the electronic information for searching the determined sharing of search of the electronic information.

According to the present invention, when a plurality of personal computers are connected to a network, searching velocity can be improved and thereby searching time can be reduced by sharing the searching of mails among a plurality of personal computers.

### BRIEF DESCRIPTION OF THE DRAWINGS

FIG. 1 is a block diagram of personal computers in the present invention.

FIG. 2A is a diagram illustrating concepts of the mail searching means in the present invention.

FIG. 2B is a diagram illustrating concepts of the mail searching means in the present invention.

FIG. 2C is a diagram illustrating concepts of the mail searching means in the present invention.

FIG. 3 is a process flow chart of a personal computer for executing a search in the present invention.

FIG. 4 is a process flow chart of a personal computer for sharing a search in the present invention.

FIG. 5 is a flow chart of new resharing of a search uncompleted mail list in the present invention.

### DETAILED DESCRIPTION OF THE PREFERRED EMBODIMENTS

The present invention will be described considering an example of searching the received mails with two personal computers. The number of personal computers for searching the mails is not limited to two units and it is also possible to conduct the search of mails with a plurality (two or more) of personal computers.

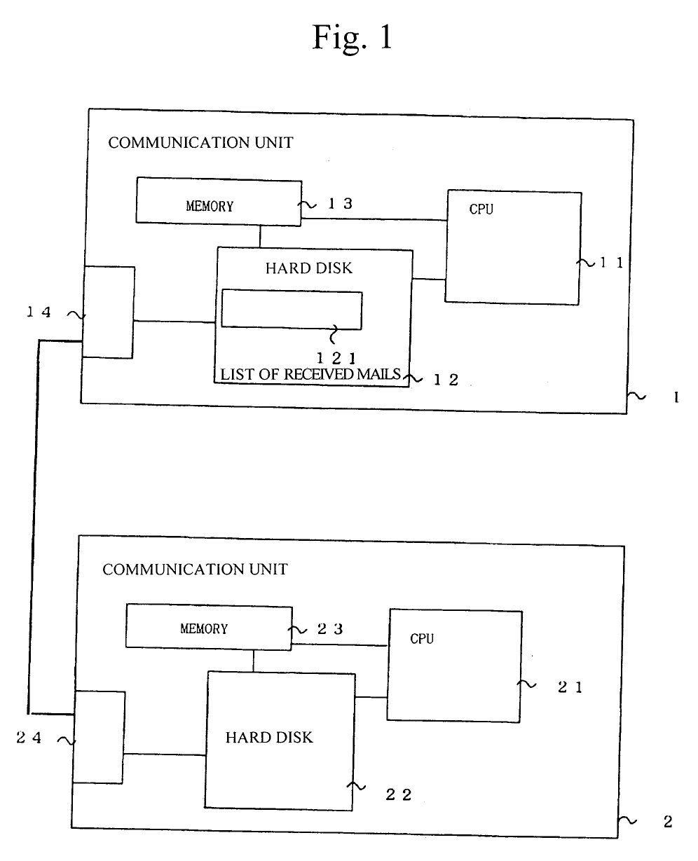

FIG. 1 is a block diagram of personal computers 1 and 2 of the present invention.

In the figure, numeral 1 denotes a personal computer; 11, a central processing unit; 12, a hard disk; 13, a memory; and 14, a communication unit.

Personal computer 1 is network-connected with the other personal computer 2 through the communication unit 14.

The hard disk 12 stores the mails received with personal computer 1. In the case of searching the desired mails from a stored list of the received mails 121, personal computer 1 transmits the list of the received mails 121 to personal computer 2. Personal computer 2 also transmits a list of the received mails of personal computer 2 to personal computer 1. Respective personal computers 1 and 2 conduct the main information matching process of the received mails and store the received mails to their respective hard disks. Here, when it is previously known that the desired mails exist in the received mails in personal computer 1, it is also possible that the list of received mails 121 is transmitted to personal computer 2 only from personal computer 1 and the mails are searched by determining the sharing of the search of the list of received mails 121.

For searching the received mails, personal computer 1 determines, with CPU 11, the sharing of received mails to be searched by personal computers 1 and 2. For example, it may be determined that personal computer 1 searches the mails received on the even number days, while personal computer 2 searches the mails received on the odd number days. Personal computer 1 instructs communication unit 14 to search the shared received mails determined for personal computer 2. Respective computers 1 and 2 search the shared received mails with the CPUs 11 and 21. The search results of personal computers 1 and 2 are displayed on a display or the like.

The storage unit in the present invention corresponds to the hard disk and the electronic information matching processing unit, electronic information sharing determining unit, and electronic information searching unit correspond to the central processing unit to perform the respective processes.

Moreover, the matching process in the present invention is similar to the mail information matching process which is conducted to realize the matching process not only of mail information but also of any type of electronic information.

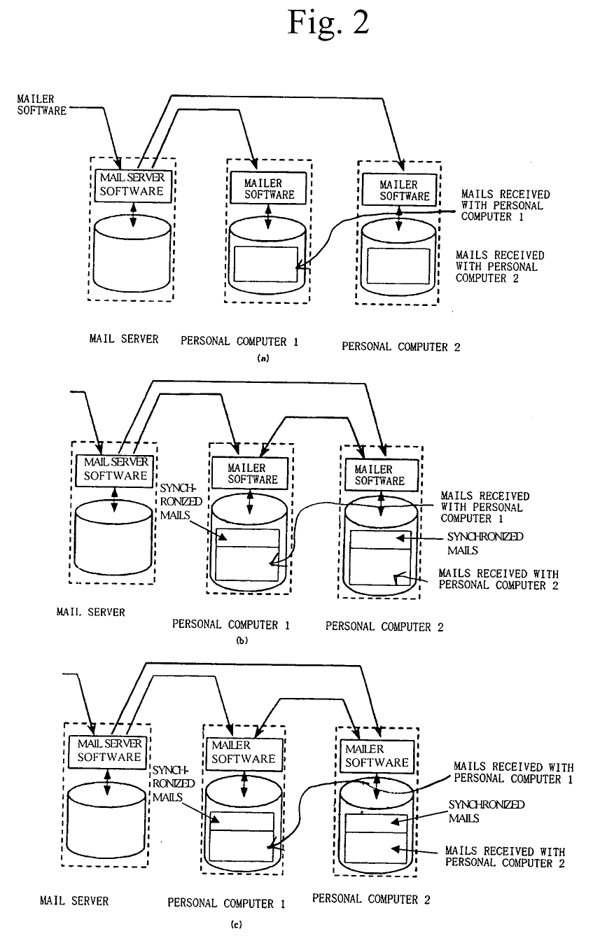

FIGS. 2A, 2B, and 2C are diagrams for illustrating the concepts of a mail searching means in the present invention.

In FIG. 2A, mails are respectively received from a unit of a mail server using two personal computers. The two personal computers 1 and 2 respectively receive different mails from the mail server.

In FIG. 2B, the received mails recorded in personal computers 1 and 2 are subjected to the main information matching process. The mails received by personal computer 1 and the mails received by personal computer 2 are subjected to the mail information process and respective mails are stored in another personal computer. The mail information matching process for the received mails may be performed for every reception of each mail or may be periodically performed. When the mail information matching process is periodically performed, if personal computers 1 and 2 receive the mails before the next mail information matching process is performed and after the preceding mail information matching process, personal computers 1 and 2 may have mail having completed the mail information matching process and also newly received mails after the mail information matching process.

FIG. 2C illustrates the concept for searching the mails received by personal computers 1 and 2. For example, when the received mail search instruction is issued in personal computer 1, personal computer 1 instructs the sharing of the received mails to be searched respectively in personal computers 1 and 2, and personal computers 1 and 2 search the received mails in the respective range. When the search of the received mails shared in personal computer 2 is completed, the search result is indicated to personal computer 1. The search results of personal computers 1 and 2 are displayed using a display or the like.

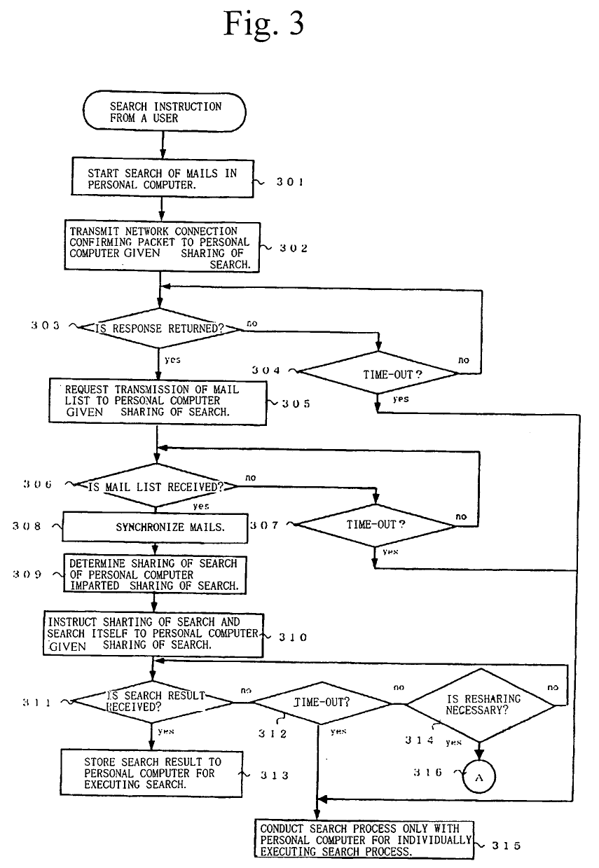

FIG. 3 is a processing flow chart of personal computer for executing the search of the received mails.

Here, the “personal computer for executing the search” indicates a personal computer which shares the search of the received mails and instructs the search to the other personal computer connected to the network and also searches the received mails shared to itself.

Moreover, the “personal computer given sharing of the search” indicates personal computer which is instructed, from personal computer for executing the search, to share the search of the received mails and notifies the search results of the shared received mails to the “personal computer for executing the search”.

When a user instructs the search of mails by designating the search condition or the like, the search of mails starts (step 301).

A personal computer, which can also search the mails, transmits, in order to confirm whether it is connected to the network or not, a network connection confirming packet to a personal computer given sharing of the search (step 302).

When it is determined that the connection confirming response has been returned as a result of determination whether the connection confirming response has been returned or not from the personal computer given sharing of the search, a request to obtain a list of the received mails of the personal computer given sharing of the search is issued to the personal computer given sharing of the search (steps 303, 305). In this case, a list of the received mails of the personal computer for executing the search is also transmitted to the personal computer given sharing of the search. If no connection confirming response is returned, whether the connection confirming response is returned or not is determined again. When the connection confirming response is not returned for a defined period and time-out occurs, the search of mails is not shared and the mail search process is performed individually (steps 304, 305). The search process to be performed here means that the personal computer for executing the search searches the list of the mails. The defined period to wait for the connection confirming response may be changed by a user and it may also have a default value, so that it is not always required to particularly set the defined waiting period.

Whether the list of mails is received or not is determined and it is proved that the list of mail is received, the mail information matching process is conducted for the mail list obtained from the personal computer given sharing of the search and the mail list of the personal computer for executing the search in order to determine the sharing of search to be conducted by the respective the personal computers (steps 306, 308, 309). For determination of the sharing of the search, the sharing of search, for example, may be determined for the personal computer which executes the search of the mails received on the even numbered days and the personal computer which executes the shared search for the mails received on the odd numbered days.

When the mail list is not received from the computer given sharing of the search, whether the mail list is received or not is determined again. When the mail list is not received for the defined period and time-out occurs, the mail search process is conducted individually (steps 307, 315). The defined period to wait for reception of the mail list may be changed by a user and it may also have a default value, so that it is not always required to particularly set the defined waiting period.

The personal computer for executing the search designates the sharing of search and the search condition or the like to the personal computer given sharing of the search in order to instruct the start of search by designating the search object mails (step 310).

Whether the mail search result is received from the personal computer given sharing of the search or not is determined. When the mail search result is received, the search result is stored in the hard disk (steps 311, 313).

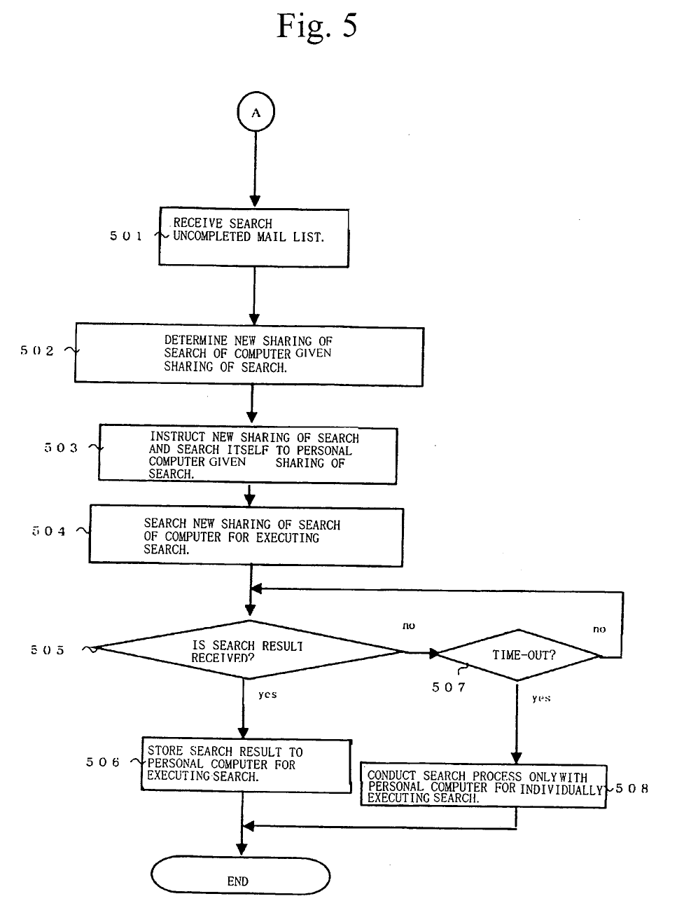

If the mail search result is not received from the personal computer given sharing of the search, whether the mail search result is received or not is determined. If the mail search result is not received for the defined period and time-out occurs, the mail search process is performed individually (steps 312,315). Here, as the search process, the personal computer for executing the search searches all mails listed in the mail list. A user may also change the defined period to wait for the reception of the mail search and it may also have a default value, so that it is not always required to particularly set the defined waiting period. When the time-out does not occur and the search shared to the personal computer for executing the search is already completed, whether a search of the uncompleted mail list for the search shared to the personal computer given sharing of the search should be newly reshared or not is determined (step 314). When resharing is necessary, the process of the step 315 for indicating the detail flows in FIG. 5 is performed. If resharing is unnecessary, whether the search result is received or not from the personal computer for executing the search is determined again (steps 314, 311).

When the mail searches of the personal computer for executing the search and the personal computer given sharing of the search have been completed, the mail search result is notified to a user through display on a display or the like. Display of the mail search result may be made periodically or non-periodically in the course of the mail search. It is not required to wait to display the mail search result until the end of the mail search.

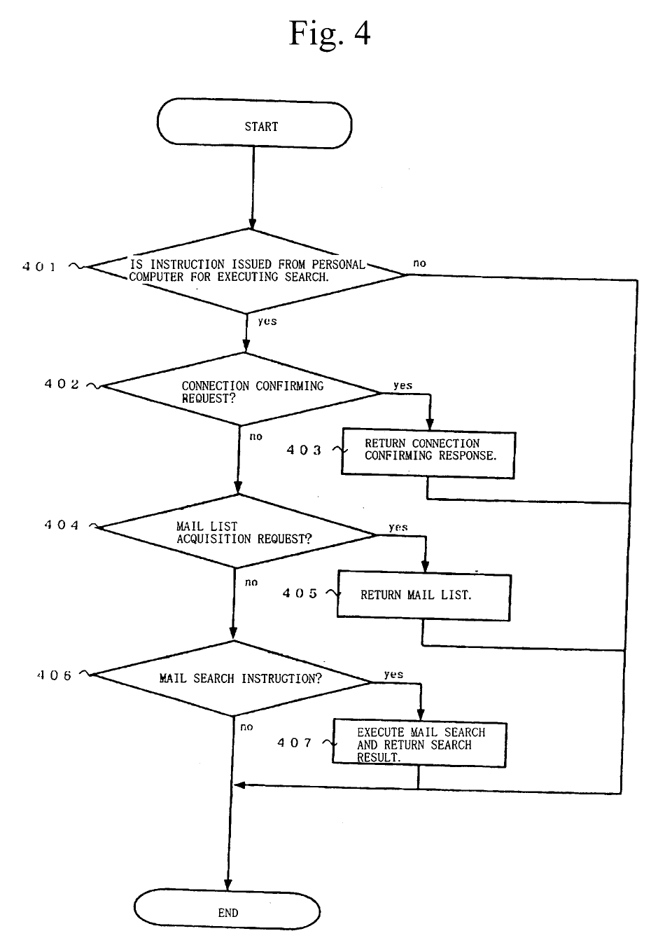

FIG. 4 is a processing flow chart of a personal computer given sharing of the search.

The personal computer given sharing of the search determines whether an instruction is issued or not from the personal computer given sharing of the search (step 401).

When the connection confirming request is issued to determine whether the network connection is set up or not, the connection confirming response is returned to the personal computer for executing the search (steps 402, 403).

When the connection confirming response is not issued, whether it is the mail list acquisition request or not is determined. When the mail list acquisition request is issued, the mail list is returned to the personal computer for executing the search (steps 404, 405).

When the mail list acquisition request is not issued, whether it is the mail search instruction or not is determined. When the mail search instruction is determined, the mail search is executed to return the search result to the personal computer for executing the search (steps 406, 407). When the mail search instruction is not issued, the process is suspended.

FIG. 5 is a flow chart for newly resharing the list including the mails which are not yet searched for the search shared to the personal computer given sharing of the search.

The search uncompleted mail list for the search shared to the personal computer given sharing of the search is received (step 501).

New sharing of the search of the personal computer given sharing of the search is determined from the search uncompleted mail list (step 502).

The search is newly shared to the personal computer given sharing of the search and the search is also instructed thereto (step 503).

New sharing of the search to the personal computer for executing the search is searched (step 504).

Whether the search result has been received or not from the personal computer given sharing of the search is determined (step 505).

When the search result has been received, the search result received is once stored to the personal computer for executing the search (step 506). If the mail search result is not received for the defined period, whether time-out occurs or not is determined (step 507).

When the mail search result is not received for the defined period and the time-out occurs, the search process is conducted only in the personal computer for individually executing the search (step 508). Here, as the search process, the personal computer for executing the search searches all contents of the search uncompleted mail list. If the time-out does not occur, whether the search result has been received again or not is determined (steps 505, 508). A user may change the setting of the defined period to wait for reception of the main search result and it may also have a default value, so that it is not always required to particularly set the defined waiting period.

The mail search process can be conducted effectively by searching the mails with the personal computer having the higher mail search processing capability.

Moreover, at the time of determining the sharing of the search of the personal computer given sharing of the search in step 303 of FIG. 3, respective search sharing may be determined in accordance with the mail search processing capability of the respective personal computers, for example, in accordance with the result of comparison of the processing capability of the central processing unit.

Determination for resharing of the mail list for the search is not always attempted only once. Namely, resharing of the search uncompleted mail list may be made when the search of mails of the personal computer for executing the search is completed, as a result of resharing, quicker than the search of the personal computer given sharing of the search. Moreover, even when the personal computer given sharing of the search has completed the search quicker than the personal computer for executing the search, the search uncompleted mail list of the personal computer given sharing of the search may be reshared.

Next, examples of changes or modifications of the embodiments of the electronic information searching apparatus of the present invention described above and the other technical expansion items will be described below.

In the above embodiments, a personal computer is used as the information processing apparatus for conducting the search of mails. But the present invention is not limited thereto and other information processing apparatus may also be used.

In the above embodiments, the received mails are stored in the hard disk, but the other storage devices, such as a flash memory, may also be used.

In the above embodiments, the received mails are considered as the search object, but the present invention is not limited thereto. Namely, transmitting mails and other electronic information may also be used.

In the above embodiments, network connection confirmation is conducted using the connection confirming packet and the connection confirming response packet, but such confirmation can be omitted through replacement with issuance of the mail list acquisition request and the response to this request. Moreover, when the sharing condition of the search can be identified previously, issuance of the mail list acquisition request and the response to such request may also be omitted.

In the above embodiments, a personal computer for executing the search is executing the search through the sharing of the received mails to be searched with each other by conducting the mail information matching process in combination with the personal computer given sharing of the search for the received mail which are not subjected to the mail information matching process during the search. However, the present invention is not limited thereto. Namely, it is possible to determine the sharing in order to execute the search with both personal computers for the mails which are not yet subjected to the main information matching process and moreover the search process can be conducted in this case after the end of the mail information matching process.

In the above embodiments, the list of all received mails existing in the other personal computer is obtained for determination of sharing of the search of received mails, but the present invention is not limited thereto. When the time and day of the final mail information matching process is known, it is possible that the mail list can be obtained by previously determining the sharing condition of the search such as even numbered days or odd numbered days, for example, for the preceding received mails. In addition, it is also possible to omit the issuance of request to obtain the mail list and the response to such request by sending the instruction for the search condition (for example, search the mails including the character string of “Patent” at the leading position of the mail) and the search object (for example, search the relevant mails from that of the specified time and date).

In the above embodiments, as an example of the sharing of search, the search process is shared to the even numbered days and odd numbered days. But, the search process is not always completed almost simultaneously because of the performance of personal computers and network. When the search process is not completed almost simultaneously, the effective search cannot be realized because it is required to wait for the end of the slower search process. Accordingly, it is also possible to share the search process so that the search process can be completed within the shorter time through execution of the more search process with personal computer having higher performance by sharing, for example, the search process of each day to each personal computer and also sharing the search process of the previous day to personal computer which has completed the search process.

In the above embodiments, the “personal computer for executing the search” and the “personal computer given sharing of the search” respectively do not each have the processing function of the other. However, it is also possible that each personal computer has the functions of both computers so that either personal computer may become the “personal computer for executing the search”.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An electronic information searching apparatus comprising:
a storage unit connected to a network and operable to store electronic information usable communicating with an other information processing apparatus;
an electronic information matching processing unit operable to perform a matching process between the electronic information stored in the storage unit and electronic information stored in the other information processing apparatus;
an electronic information sharing determining unit operable to determine sharing of electronic information that is to be searched of the electronic information having completed the electronic information matching process; and
an electronic information searching unit operable to search the determined shared electronic information.

2. The electronic information searching apparatus according to claim 1, wherein the electronic information searching unit is further operable to assist in a search process of the other information processing apparatus, when the electronic information searching unit has completed its search of the determined shared information and when the search process of the other information processing apparatus is not yet completed.

3. The electronic information searching apparatus according to claim 1, wherein the electronic information sharing determining unit is further operable to determine the sharing of the electronic information to be searched in accordance with a searching process capability of the electronic information to be searched.

4. The information processing apparatus according to claim 1, wherein the electronic information matching processing unit is further operable to store a history of the electronic information matching processes, to receive only the electronic information not yet subjected to the electronic information matching process from the other information processing apparatus, and to perform the electronic information matching process again.

5. The electronic information searching apparatus according to claim 1, wherein the electronic information is non-voice information transmitted and received by the information processing apparatus.

6. The electronic information searching apparatus according to claim 1, wherein the electronic information is electronic mail information transmitted and received by the information processing apparatus.

7. An electronic information searching program for searching electronic information stored in an information processing apparatus in combination with an other information processing unit connected to a network, the program executable by a processor to perform:
an electronic information matching processing step which performs a matching process between electronic information of the other information processing apparatus and stored electronic information stored in the information processing apparatus;
an electronic information sharing determining step which determines sharing of electronic information to be searched of the electronic information having completed the matching process; and
an electronic information searching step which searches the determined shared electronic information.

8. The electronic information searching program according to claim 7, wherein the program is further executable by the processor to perform a search process step to assist other information processing apparatus, when the electronic information searching step has completed its search of the determined shared information and when a search process of the other information processing apparatus is not yet completed.

9. The electronic information searching program according to claim 7, wherein the program is further executable by the processor to perform an electronic information sharing determining step to determine the sharing of the electronic information to be searched in accordance with a searching process capability of the electronic information to be searched.

10. The electronic information searching program according to claim 7, wherein the program is further executable by the processor to perform storing a history of the electronic information matching processes, receiving only the electronic information not yet subjected to the electronic information matching process from the other information processing apparatus, and performing the electronic information matching process again.

11. The electronic information searching program according to claim 7, wherein the electronic information is non-voice information transmitted and received by the information processing apparatus.

12. The electronic information searching program according to claim 7, wherein the electronic information is electronic mail information transmitted and received by the information processing apparatus.

13. A computer-readable storage medium recording an electronic information searching program for searching electronic information stored in an information processing apparatus in combination with an other information processing apparatus connected to a network , the program executable by a processor to perform:
an electronic information matching processing step which performs a matching process between electronic information of the other information processing apparatus and stored electronic information stored in the information processing apparatus;
an electronic information sharing determining step which determines sharing of electronic information to be searched of the electronic information having completed the matching process; and
an electronic information searching step which searches the determined shared electronic information.

14. The computer-readable storage medium of claim 13, wherein the electronic information searching program is further executable by the processor to perform a search process step to assist other information processing apparatus, when the electronic information searching step has completed its search of the determined shared information and when a search process of the other information processing apparatus is not yet completed.

15. The computer-readable storage medium of claim 13, wherein the electronic information searching program is further executable by the processor to perform an electronic information sharing determining step to determine the sharing of the electronic information to be searched in accordance with a searching process capability of the electronic information to be searched.

16. The computer-readable storage medium of claim 13, wherein the electronic information searching program is further executable by the processor to perform storing a history of the electronic information matching processes, receiving only the electronic information not yet subjected to the electronic information matching process from the other information processing apparatus, and performing the electronic information matching process again.

17. The electronic information searching program according to claim 13, wherein the electronic information is non-voice information transmitted and received by the information processing apparatus.

18. The electronic information searching program according to claim 13, wherein the electronic information is electronic mail information transmitted and received by the information processing apparatus.

19. The electronic information searching method for searching electronic information stored in an information processing apparatus in combination with an other information processing apparatus connected to a network, the method comprising;
an electronic information matching processing step which performs a matching process between electronic information of the other information processing apparatus and stored electronic information stored in the information processing apparatus;
an electronic information sharing determining step which determines sharing of electronic information to be searched of the electronic information having completed the matching process; and
an electronic information searching step which searches the determined shared electronic information.

20. The method of claim 19, further comprising a search process step to assist other information processing apparatus, when the electronic information searching step has completed its search of the determined shared information and when a search process of the other information processing apparatus is not yet completed.

21. The method of claim 19, further comprising an electronic information sharing determining step to determine the sharing of the electronic information to be searched in accordance with a searching process capability of the electronic information to be searched.

22. The method of claim 19, further comprising storing a history of the electronic information matching processes, receiving only the electronic information not yet subjected to the electronic information matching process from the other information processing apparatus, and performing the electronic information matching process again.

23. The electronic information searching program according to claim 19, wherein the electronic information is non-voice information transmitted and received by the information processing apparatus.

24. The electronic information searching program according to claim 19, wherein the electronic information is electronic mail information transmitted and received by the information processing apparatus.
